(19) United States
(12) Patent Application Publication
(10) Pub. No.: US 2012/0216040 A1
(43) Pub. Date: Aug. 23, 2012

(54) System for Email Message Authentication, Classification, Encryption and Message Authenticity

(76) Inventors: Ram Tanamy, Brooklyn, NY (US); Guy Tanamy, Petach Tiqva (IL)

(21) Appl. No.: 13/029,233

(22) Filed: Feb. 17, 2011

(51) Int. Cl. H04L 9/32

(52) U.S. Cl. 713/170

(57) ABSTRACT

A system and method for tracking sender activities to provide proper classifications as a sender or of its email messages. Certain embodiments of the present invention can track the number of messages sent from a specific email address. By doing so, the system and method permits each user to define an acceptable threshold of the number of recipients of each one message received by the user.

### FIELD OF INVENTION

The present invention is generally in the field of electronic messaging, and more specifically in the field of email message security, authentication and filtering. The present invention further relates to message security, authentication and filtering in other fields of electronic messaging such as SMS messaging, instant messaging and the like.

### BACKGROUND OF THE INVENTION

Electronic communications are ubiquitous. According to the research firm The Radicati Group, Inc., as of 2010 there existed 2.9 billion email accounts. According to the same firm, on average, over 200 billion email messages are sent daily, with roughly 18% of those being unsolicited “spam”. Furthermore, The Radicati Group estimates that in 2010 there are approximately 2.4 billion instant messaging accounts and 2.2 billion social networking accounts, the latter of which may be used for interpersonal communication. Businesses expend significant resources blocking and managing unwanted, unsolicited “spam” communications. By some estimates as much as $1,000 per user.

The Simple Mail Transport Protocol (SMTP) as defined in RFC 821 and later in RFC 2821 standard on which current email communications are based, does not directly provide mechanisms to prevent the use of falsified email addresses (sometimes known as “spoofed” email addresses), to ensure the integrity of messages, nor to address unwanted, commercial email (commonly referred to as “spam”).

In connection with spoofed email addresses, SMTP provides a mechanism to determine a reverse-path in the protocol MAIL FROM field, also known as the Return-Path. There is also a From Address field provided for in the SMTP transport protocol (i.e., in the DATA transaction specified by the SMTP protocol). The From Address field is presented to the recipient in its mail client and this is the field that enable the trust in the sender by the recipient. Unfortunately, the protocol does not provide the method to authenticate and verify either the Return-Address or the From Address. Senders are able forge these addresses while sending unsolicited email messages.

Numerous solutions have been suggested for more efficiently and cost effectively managing unwanted, unsolicited “spam” communications, to ensure message integrity and to address spoofed sender identities. None have been completely adequate to date.

One proposed solution is the Sender Policy Framework. As defined in RFC 4408, the Sender Policy Framework uses the sending domain part in the Mail From (Return-Address) fields to validated that which hosts allow to send from this domain. The Sender Policy Framework records are available by the domain DNS Resource Records. The Sender Policy Framework resolves mainly the spoofing issue with the mail protocol; however, any Spammer can define its own Sender Policy Framework records and still send unsolicited email messages. Sender Policy Framework therefore provides only domain level authentication of hosts' senders but does not provide a method to classify the sender or the incoming email messages and monitor the rate of usage.

Another proposed solution is the Domain Keys Identified Email Signatures (defined in RFC 5863). This proposed method would enable recipients to validate the sending site using domain-level digital signatures authentication. As with Sender Policy Framework, Domain Keys Identified Email Signatures can only guarantee that the sender either sent from domain allowed hosts or on its behalf. Thus its only solve the problem of domain spoofing. It does not prevent a spammer from using the same domain, such as Yahoo.com to send spam email to multiple recipients. Furthermore, the method itself can be used by Spammers to use their own domains to send bulk email messages. The method does not provide a mechanism for the recipient to validate the quality of the message itself.

Similarly, the proposed Sender ID Frameworks, much like the Sender Policy Framework and the Domain Keys Identified Email Signatures, has a main goal to verify that email messages originate from the domain which the sender claims to be sending it. In this proposed system, a recipient's mail transport agent checks the sender domain DNS records to validate the sender's server. Sender ID Frameworks solves the problem of spoofing but still enables a user in the same domain to send bulk email.

The three foregoing proposals do not operate properly where users utilize multiple SMTP servers. User commonly have multiple email addresses and multiple mail clients (e.g., desk top, webmail, mobile) at multiple locations (office, home, wireless etc). As indicated before, these methods can be used by spammers too using their own domain or ISP domains. There is no classification of senders or email messages.

Solutions apart from SMTP related proposed solutions have also been proposed. For example, Real Time Blackhole Lists are lists of IP addresses that are to believed to be used by spammers. Theses IPs are either belong to spammers or managed by ISPs that allow spammers to use their network. While this method tries to be accurate and fair it fails when a valid domain is shared the same network of a spammer, it does not prevent spammers from moving between networks, causing IPs that later are being used by others to be in the Realtime Blackhole List. Furthermore, when a recipient removes an IP address from a list, for example, when a valid message is blocked, the user loses the protection for unwanted messages sent from the same IP address. The Realtime Blackhole List is therefore not accurate and is intrusive to usage of email communications.

Solutions based on filtering by end users have also been presented. For example, filtering may use pattern and statistical mathematical methods to classify email as spam or valid email. While the methods were improved and the accuracy was increased over the years, they are still inadequate. For example, these methods produce false positives in which a good email messages are identified as spam.

Other proposed solutions include, for example, U.S. Pat. No. 7,571,319, which presents a system and method of validating inbound electronic messages by including a latent cryptographic identifier in each inbound message. This methodology does not account adequately, if at all, for quantity of messages sent from a particular source nor does it consider the content of any messages.

U.S. Pat. No. 7,769,815 presents a system and method for filtering spam email messages by checking the relationship between a sender of a message and a recipient of the message. The spam detecting system identifies the relationship between the sender and recipient as ‘unknown’ or ‘trusted’. If the message is ‘trusted’, the message is transmitted accordingly to the recipient. If the message is classified as ‘unknown’, then the message is analyzed in view of other identified potential spam messages where a count is tallied against a threshold value to keep track of the probability a message is spam. This system has the shortcoming of re1quiring knowledge of the relationship between sender and receive, which relationship may not always be known.

U.S. Pat. No. 6,507,866 presents a system and method for filtering spam email messages by receiving e-mail messages, storing fields including at least one field from the header of each received e-mail message and analyzing the stored fields for at least one pattern indicative of undesired e-mail messages. This disclosed system and method has the undesirable attribute, among others, of being local to a single user.

Other known systems and methods employ public/private key pairs, requiring a publicly accessible “key server” to manage public keys. These systems and methods have the disadvantage, among others, of not directly addressing the issue of mass mail spam, only integrity and identity of sent messages.

Still other known systems and methods, such as the one disclosed in published U.S. application no. 2008/0046579, disclose authentication servers used to determine if senders of messages are approved by intended recipients or are otherwise on approved sender lists. These systems have the disadvantage, among others, of not addressing mass mailed spam and of requiring approved sender lists, also known as “white lists.”

With the limitations of the art known, it is desirable to have a system for managing electronic communications to minimize or eliminate unwanted commercial communications (“spam”), to ensure message security and integrity, without the limitations inherent in the prior art.

### SUMMARY OF THE INVENTION

In certain embodiments of the present invention, the present invention provides a system and method for tracking sender activities to provide proper classifications as a sender or of its email messages. For example, the system and method of certain embodiments of the present invention can track the number of messages sent from a specific email address. By doing so, the system and method permits each user to define an acceptable threshold of the number of recipients of each one message received by the user.

The method and system in accordance with embodiments of the present invention provide a mechanism which, first and foremost, ensures proper identification and authentication of senders and prevents spoofed email addresses (i.e., email identify theft). It also enables the classification of senders and messages to help reject spam. The method and system also facilitates and simplifies the ability to automatically send and receive encrypted email message between senders and recipients. Also, the method and system may simplify the ability to digitally sign email messages to ensure the integrity and non-repudiation of the origin.

To implement the foregoing, embodiments of the present invention may employ a Message Authentication Server (“MAS”) to manage message tracking and/or authenticating functions. Such Message Authentication Servers may review and validate any and all aspects of messages, including among others message authenticity, integrity and volume (i.e., the number of times the same or similar message has been sent by a particular sender or senders, as described more fully below).

Message Authentication Servers must be trusted; that is, the Message Authentication Server must be known to be controlled by a trusted operator and to provide message processing and associated output with useful and truthful results. Stated differently, Message Authentication Servers must be known to provide information on messages that serves the desired ends described herein. With this in mind, a trusted central authority may operate known-to-be-trustworthy Message Authentication Servers. Additionally, such a trusted central authority may certify (and de-certify, as necessary) third party Message Authentication Servers, for example, so that an entity such as Google, Microsoft or others providers of consumer and business messaging services could operate their own Message Authentication Servers.

MAS's of the present invention may generate email header keys, accept requests to verify email addresses and keys, and may also contain public and private key data for various email addresses and/or users. The MAS may automatically generate the public/private key pair for email addresses that require secure email or provide a mechanism for users or email system administrator on behalf of their users to upload their own generated public keys.

Embodiments of the present invention may further include a Registration Site. A Registration Site is a site at which a user registers for Message Authentication (“MA”) service. Message Authentication may alternatively be called “Address Authentication” in instances where messages are authenticated by authentication of the message sender's address. The term “Message Authentication” should not be interpreted to limit the present invention by excluding embodiments which authenticate messages by authentication of a sender's address, such embodiments expressly being included.

If a domain manages its own Message Authentication Server (“MAS”), it can set up the MA services for users (for example, subscribers to the domain's email service) without the specific user request and approval. Large organizations, ISPs and Email Hosting Providers may have their own MAS to allow for scalability and control by such entities. Users may subscribe for MA Service with or without encryption, as detailed more fully below. Users may subscribe for MA Service with or without encryption and with or without digital signing, as detailed more fully below

Embodiments of the present invention may also include a Message Authentication Directory (“MA Directory”). A Message Authentication Directory is a searchable list of domains having MAS'. The MA Directory may also include addresses for domains' MAS', along with any other desired information. The MA Directory may operate in a similar fashion to present whois servers, but instead of proving information about domain owners and the associated DNS servers (i.e., the MA Directory acts as an associator of senders and servers), it will provide the list of Message Authentication Servers for the domain. The MA Directory may be implemented with similar functionality and design to current DNS servers. For example, MA Directory records may be cached to reduce the load on the MA Directory.

As describe previously, a central authority may provide Message Authentication Servers for domains not providing their own. In such instances, there may be a default Message Authentication Server for domains that are not in the MA Directory.

The MA Directories may be operated by the internet community and be delegated by the domain TLD. For example, the MA Directory for the .com TLD may be managed by ARIN, .MIL by the military, and .GOV by the government. Like the whois unix utility, there will be whereis domainName to get the MAS the domain. The query will be submitted to the proper server according the domain TLD.

In certain embodiments of the present invention, software and/or hardware modules may be employed for end-users. For example, message authentication clients (“MAC”) in the form of plug-in software modules may be installed in the end user email clients such as Microsoft Outlook, Mozilla Thunderbird, MacMail, and the like. MACs may verify received emails by interaction with MAS'. Additionally, MAC may encode encrypted received email messages, using its its own (recipient) private key, verify digitally signed messages with sender public key. If set, MACs encrypt outgoing email messages with recipients public key. If set, MAC digitally signed outgoing emails message using its own sender private key”. The encryption and signing method will be using the S/MIME standard.

In other embodiments of the present invention, there may be provided a message authentication mail server (“MAMS”), which may add a message authentication key on behalf of senders and/or check message authentication keys on behalf of recipients. When encryption requires, then the MAMS may encrypt outgoing messages or decrypt incoming messages if required. If required, outgoing email messages may be digitally signed or incoming email messages may be verified. The action can be dictated by user option setting.

Embodiments of the present invention may include a message authentication database which may contain all or some of the email address records with the following information:
TTL (Time To Live)—How long the key will be valid. If the TTL is 0, it will exist forever until if and when the key is compromised.
Count Limit—To how many recipients the sender is allowed to send the same message. This value is set by the end user or admin to be able to monitor if a key was stolen. A user can set to a low or high value according to his/her needs.
Expiration time—When the Current Key will expire.

Embodiments of the present invention may include a MAS activities and monitor database to maintain data on sender activities. The data may be collected when a recipient sends request for verification of a message to the MAS (e.g., when an end-user's plug-in module does so). This data enables the MAS to reply to the validation request with classification and rating information for the email in question. Such classification and rating information may include, for example, one or more of the following, each data item which the MAS may store:
Number of active days for the message;
Total sent messages by the sender of the message in question (or aggregated with other messages sent by the sender);
Total recipients of the message in question (or aggregated with other messages sent by the sender);
Total sent messages of the message in question (or aggregated with other messages sent by the sender) in the last 30 days;
Total sent recipients in the last 30 days of the message in question (or aggregated with other messages sent by the sender);
Total sent messages in the last 7 day of the message in question (or aggregated with other messages sent by the sender);
Total sent recipients in the last 7 days of the message in question (or aggregated with other messages sent by the sender);
Total sent messages in the last 24 hours of the message in question (or aggregated with other messages sent by the sender);
Total sent recipients in the last 24 hours of the message in question (or aggregated with other messages sent by the sender);
Daily rate of sent messages of the message in question (or aggregated with other messages sent by the sender); and
Total number of recipients of the message in question (or aggregated with other messages sent by the sender).

The validation request may include an identifier of the sender of the message for which validation is being requested. This identifier may be in the form of an “X-AUTH-KEY” value (i.e., a sender authorization key) for the message. The X-AUTH-KEY value may be generated by the MAS of the messaging system from which the message originated. The X-AUTH-KEY value is unique for each sender address (e.g., for each sender email address).

The MAS activities and monitor database records may be updated when a recipient sends a verification request to a MAS (e.g., when a recipient's plug-in does so). If the message sent by a particular sender, as may be identified by the sender's key, exceeds predetermined limits, the MAS may generate a new key for the sender and send it to sender email address. The MAC can then capture the new key and use it in subsequent outgoing message processing. Automatic generation of new keys and updating this information in clients addresses the possible case of stolen keys, which would allow for the forging of email messages on behalf of senders.

Using the MAS activities and monitor database (or, in other embodiments, one or more other databases), the MAS may provide one or more pieces of the following information to users in response to a validation request:
X-AUTH-VALID—The X-AUTH-VALID field may be set to a value of “true” if the message's sender email address exists in the MAS and the X-AUTH-KEY matches the currently valid key for the sender, otherwise it may be set to a value of “false”.
X-AUTH-NOT-VALID—A field set to “true” (or present, if present only when true) if the message's X-AUTH-KEY does not match to the current, valid key for the sender.
X-AUTH-EXIST—A field set to “true” (or present, if present only when true) if the sender exists in the MAS (e.g., in the MAS' activities and monitor database).
X-AUTH-VALID-EXCEED—A field set to “true” (or present, if present only when true) if the X-AUTH-KEY is valid for the sender but but the number of recipients count is greater than the predetermined limit. Where this field is “true” (or present, if present only when true), then the message being validated may be considered spam because of the volume in which it was sent.
X-AUTH-COUNTER—A counter field holding the number of recipients for the message if the X-AUTH-VALID is set to “true”.
X-AUTH-SENDER-CLASS—A field which may be utilized to provide a sender class. Examples of sender classes include:
   LIGHT—light user
   NORMAL—normal usage of email
   EXCESSIVE—the user send a lot of email messages. This can be considered to be spam or bulk email.

Embodiments of the present invention may include a network of addresses database (“NOA Database”), the purpose of which is to collect and provide information about relationships between senders and recipients. For example, when a sender sends an email, the mail client/mail server may notify the sender ‘s MAS and provide it with the sender's and the recipient's email addresses. The information may then be collected in the MAS’ NOA Database so that when a recipient subsequently sends a message to the sender, the information will be available for additional message classification. In connection with this, the NOA Database may maintain the following information:
The first time the recipient sent a message to the sender;
The number of messages the recipient has sent to the sender;
The frequency of messages the recipient has sent to the sender;
The number of messages the sender has sent to the recipient; and
The frequency of messages the sender has sent to the recipient.

Given the above information, the MAS will be able to determine information concerning interrelationships between various users of the messaging system, e.g., relationships between various senders and recipients of messages. For example, the information collected and stored in the NOA Database may enable the MAS to provide additional classification of the sender and the message, including classifications such as: “never connected”; “some connected to”; “lightly connected”; and “trusted”. The classification results can be refined to define more granular classification, as will be readily understood by those of skill in the art. The classification may be provided in response to validation requests, for example, by providing the value in a X-AUTH-SENDER-CONNECTION field.

Users may process messages (e.g., the message software may filter messages), based in whole or in part on the information supplied to the user in response to a validation request. For example, message plug-ins can mark a message according to the reply's X-AUTH-SENDER-CLASS or X-AUTH-SENDER-CONNECTION fields.

For end-users to implement one or more of the foregoing embodiments, the following steps (or similar steps) may be undertaken:
(1) The end user subscribes to the MAS. The user can set up the service with encryption or without encryption. The MAS provides a web site form for the user to subscribe for the service.
(2) The user enter its email address to subscribe and indicates if encryption is required or not. The system checks if the email address already exist in the system, if it exist, the system provide an error to the user, otherwise, the system send a message confirmation to the same email address with instruction and one click URL to activate the MAS for the user.
(3) When the user gets the email message from the MAS, it will be requested to click on the confirmation link that will be provided in the email message. Once the user click on the confirmation, the system set the records for user in the MAS and it prompt the user to download the plug-in for its mail client.
(4) Once the plug-in is installed, it sends a request to the MA Systems to request its X-AUTH-KEY. The MAS sends the X-AUTH-KEY to the email address. The plug-in captures the key and stores it for future usage when it send email. The plug-in will generate a secure connection to the MAS. The plug-in creates a random pair of private-key and public-key to be used once for the purpose of getting its email address private key from MAS. It sends the public key to the MAS and gets its email address private key using the temporary public-key that was generated by the plug-in.

When the mail client's plug-in receives the encrypted private key, it saves it locally for future use. The MAS optionally can enable the user to provide its own generated, purchased Public key to the system. The user will have the ability to configure its own private-key in its mail client or its own mail server.

### DESCRIPTION OF DRAWINGS

FIG. 1 is a system diagram showing the modules of a preferred embodiment and communications between them in accordance with a preferred embodiment.

FIGS. 2 through 5 are flowcharts depicting the processing steps of a preferred embodiment.

### DESCRIPTION OF THE PREFERRED EMBODIMENT

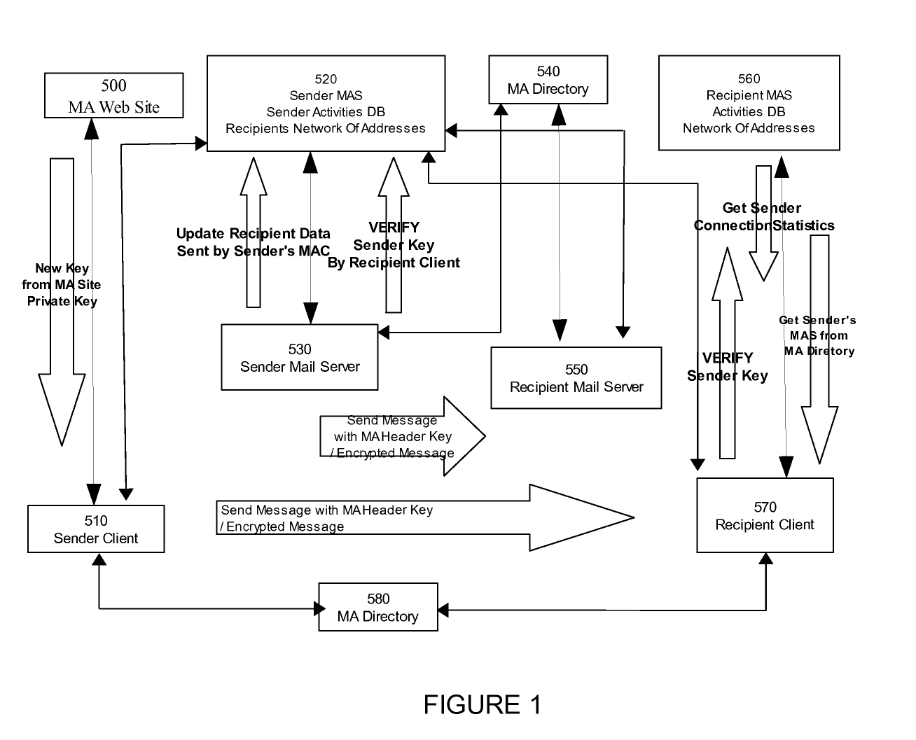

Referring first to FIG. 1, MA Website (or MA server), 500 enables users to register for message authentication services as described herein. The MA server sends users' new MA key and private key to sender's clients, to sender clients, 510.

When sending a message, sender client 510 connects to MA Directory 580 to obtain the sender's domain MA. The sender client connects to sender MAS, 520, for example to update sender's activities DB with the recipient's address. The sender client, 510, may also send the message to recipient 570 a MA header key and optionally an encrypted message.

Recipient Client 570 connects to MA directory 580 to obtain the sender's domain MAS. Subsequently, the recipient client 570 may send a VERIFY request to sender MAS 520 and receive in response a message transformed with one or more X-AUTH-XXXX values. The Recipient Client 570 may obtain the recipient's MAS address from the MA Directory 580 and thereafter send a request to recipient's MA 560 to obtain sender X-AUTH-SENDER-XXXX values.

In embodiments where the mail servers process the message authentication, the sender mail server 530 may connect to MA Directory 540 to obtain the sender's MAS. The mail server 530 sends the message with sender's MA header key, optionally encrypting the message, to recipient's mail server, 550. The recipient's mail server, 550, may connect to MA Directory 540 to obtain the Sender's domain MAS, 520. Thereafter the recipient's mail server may send a VERIFY request to sender's domain MAS, 520 and receive back a reply with X-AUTH-XXXX values.

In certain embodiments, the recipient's mail server may connect to the MA Directory 540 to obtain the recipient's MAS. The Recipient's Mail Server may then connect to recipient's MAS 560 to obtain sender X-AUTH-SENDER-XXXX values.

Messages may be sent in three manners (among others): with only a message client (e.g., an email client); via a message server (e.g., an email server); or a combination of message client and message server. In the first scenario, the message client attaches to the message, for example, in a header of the outgoing message, an X-AUTH-KEY field. The message client may also attach an X-AUTH-AGENT field to identify the message client type (e.g., the email client application such as Microsoft Outlook), and may attach an X-AUTH-VERSION field to identify agent version.

In the second scenario, the message server attaches the information (e.g., the headers) as just described.

In the third scenario, the message client attaches the information (e.g., the headers) as previously described. Thereafter, the message server checks the information attached to the message by the client and makes any corrections and/or additions which may be necessary. The message server in this scenario may send a message to the message client indicating any changes and/or additions made by the message server. In this manner, the message client has the opportunity to update its information for use in subsequent messages.

In any of the foregoing scenarios, the outgoing message may be encrypted. If the message client is set to send messages encrypted, the message client (or a plug-in for it) may encrypt the message using the recipient's email address public-key using S/MIME method.

Receiving messages in accordance with embodiments of the present invention may also be done either by a receiving message client alone or by a receiving mail client in conjunction with a receiving message server as well.

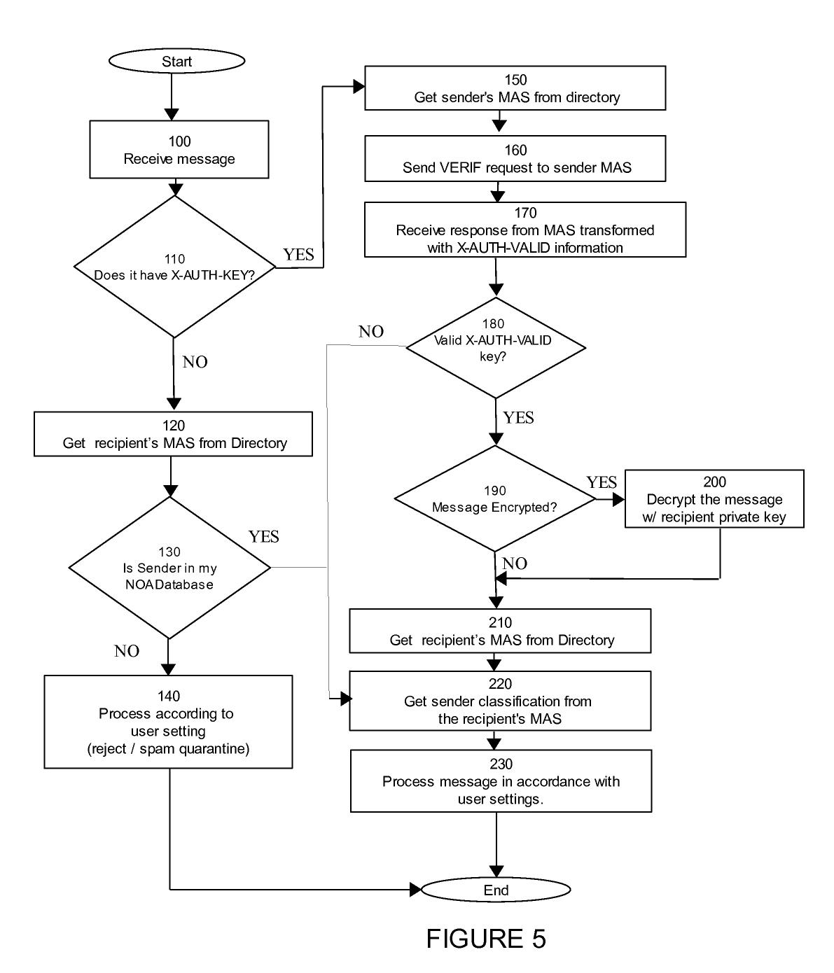

In one scenario, depicted in FIG. 5, the message client (e.g., via a plug-in) receives a message, 100. The client then parses the incoming message to extract the X-AUTH-KEY value, for example, from a message header, 110. If the incoming message has no X-AUTH-KEY, the client may obtain the address of the recipient's MAS from the MAS directory, 120, and thereafter query the recipient's MAS to determine if the sender is in the recipient's NOA database (query step not shown), 130. If the sender is not in the recipient's NOA database, the system may process the message in accordance with the user's pre-defined instructions for such cases, for example, by placing the message in a “spam folder,” 140.

If in step 110 the message has an X-AUTH-KEY, the client then the client performs a lookup of the senders MAS, 150, sends a VERIF (verify) request to the MAS, 160, and receives back from the MAS the message transformed with authentication information, 170. Step 150 may be accomplished by querying the proper MA Directory according to the domain TLD, as detailed above. Step 160 may be accomplished by providing the sender's message address (e.g., the sender's email address), the parsed X-AUTH-KEY value and additional message specific information such as header's Message-ID, sender time and sender's IP. The MAS response to the VERIF request may be as detailed above.

Upon receiving the MAS response, the client determines whether the transformed message includes a valid X-AUTH-VALID key, 180. If not, processing may proceed to step 220, where the client receive from the recipient's MAS a further transformed message, transformed with classification information for the sender, as described above, for example, in connection with X-AUTH-SENDER-CONNECTION information (the steps for obtaining the recipient's MAS address not shown but being as described previously). The system may then process the message in accordance with the user's pre-defined instructions for such cases, for example, by placing the message in a “spam folder,” 230. Alternatively, step 220 may be skipped, and processing flowing from 180 directly to 230.

For valid messages as determined by step 180, processing proceeds to 190, where the client determines whether the message is encrypted. If so, the recipient's client can un-encrypt messages as will be readily understood by those of skill in the art, 200. Similarly, for digitally signed messages, either the recipient's message server or the recipient's client can verify signed messages as will be readily understood by those of skill in the art.

Next, the client may optionally query the recipient's MAS, first by determining the identity of that MAS from a directory, 210, as described above. The client may then receive from the recipient's MAS a further transformed message, 220, as described above. Finally, the client may process the message in accordance with predefined processing instructions, 230.

In the second scenario, when a recipient's message server receives a message, it may issue a VERIF requests to the sender's MAS as described in connection with the former scenario. In this case, the recipient's message server can handle the response from the sender's MAS in a manner similar to the manner described for the prior scenario.

In either scenario, the recipient's message server or client can cache for a period of time the sender's keys for trusted email address to reduce overhead checking with the MAS. If the key matches and the sender is trusted, then it might not require verification with the sender's MAS. The decision of verify the sender with the MAS can depends on the trust history of the recipient has with the sender provided that the key that is provided matched the cached key.

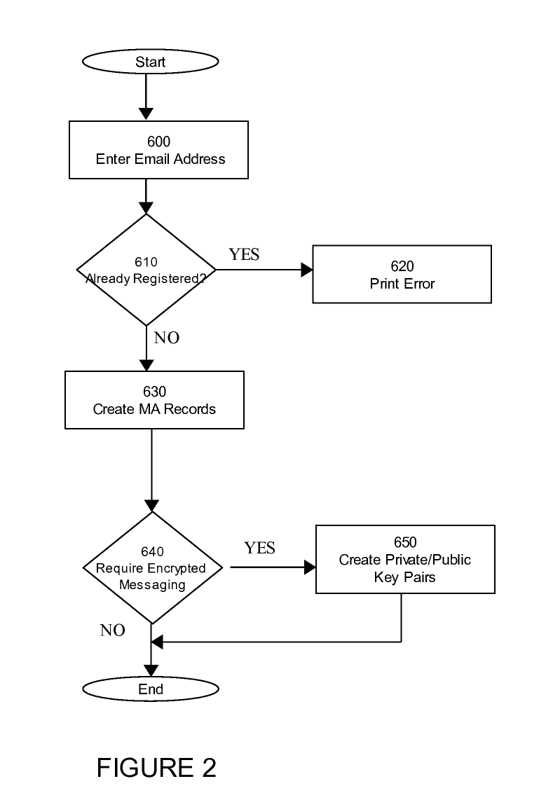

Referring now to FIG. 2, embodiments of the present invention may register an email address (or other messaging address in the same manner) as detailed therein. First, an email address is entered, 600. This may be accomplished automatically via client software or manually by presenting a user with an appropriate HTML form or the like, as will be readily understood by those of skill in the art. Next, the system determines whether the address is already registered, 610. If so, the system may trigger an error message, 620, or may simply ignore the request. If at 610 the address is not determined to be previously registered, the system creates appropriate MA (message authentication) records as described in more detail previously. Next, the system may determine whether or not the user associated with the address, or the users email system, requires message encryption, 640. If so, the system creates the necessary private/public key pairs, 650, as will be readily understood by those of skill in the art.

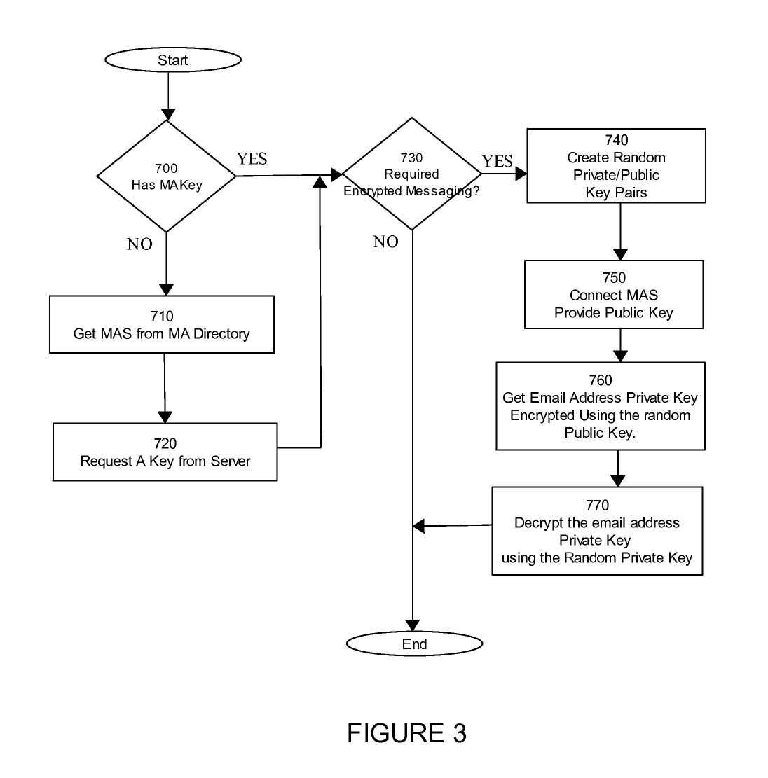

Referring now to FIG. 3, embodiments of the present invention may initially implement (setup) client plugins described above as follows. First, the client mail (or other messaging system) determines whether the user has an MA key, 700. If not, the system retrieves the address of the MAS from the MA Directory, 710, and queries the MAS for the user's key, 710. Once a key is obtained (or if one was already present), the system determines whether the user requires encrypted messaging, 730, if not, processing is complete. If so, the system generates a random public/private key pair, 740. The system then queries the MA Directory to obtain the MAS, 745. Step 745 may be skipped if the system already obtained and cached the MAS address in step 710.

After obtaining the MAS address, the client may connect to the MAS and provide the public key, 750. The MAS thereafter uses the public key to encrypt a new private key, which is received back at the client, 760. The client then uses the random private key to decrypt the message private key returned from the MAS, 770. This private key is stored by the client for subsequent use in outgoing messages.

Message servers may be initialized in the same manner as clients.

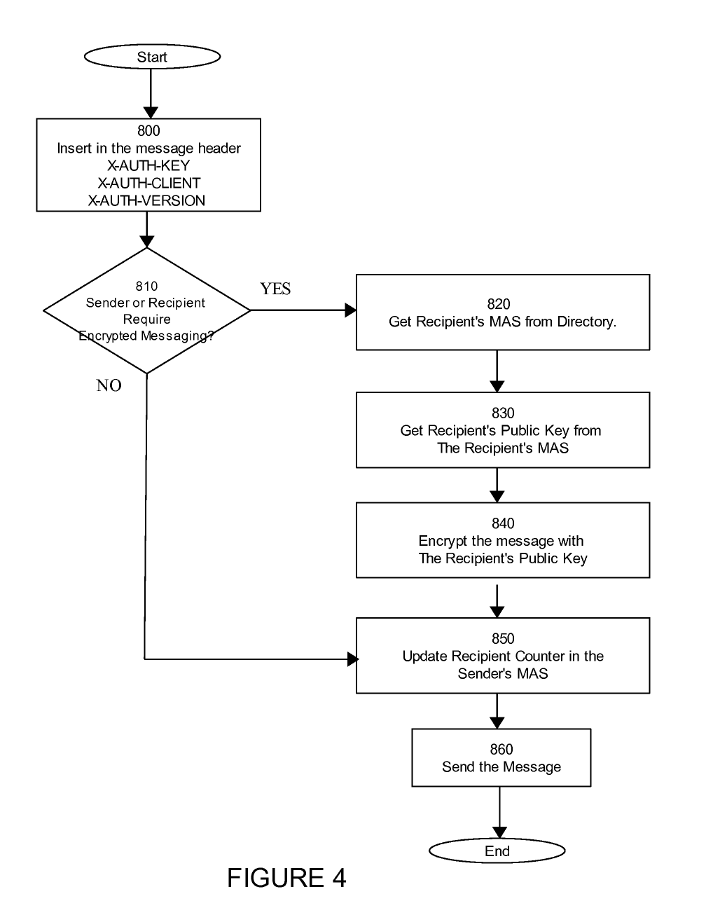

Embodiments of the present invention may send messages as detailed in FIG. 4. First, the sender's message system (either at the client or server level) inserts into the message the X-AUTH-KEY, X-AUTH-CLIENT or X-AUTH-SERVER (which holds client and/or server implementation information) and X-AUTH-VERSION (which holds client and/or server version information) headers, 800. The system next determines whether the sender or recipient require message encryption, 810, if not, the message is processed next in step 850, described further below.

If at step 810 encryption is determined to be required, the system performs a lookup of the recipient's MAS in the MAS directory, 820. Upon receiving the recipient's MAS address, the system obtains the recipient's public key, 830, and encrypts the outgoing message using it, 840.

With or without encryption, processing continues in step 850, where the system updates an internally managed counter for the recipient to track total messages sent from the sender to the recipient. By maintaining this information, the system may later analyze the nature of the sender/recipient relationship heuristically (e.g., by determining how often the sender and recipient communicate). The message is then sent, 860.

Finally, certain embodiments of the present invention may provide for secure message archiving. This may be important, for example, to meet the critical requirements for health care providers and financial service providers. In both cases, organizational requirements include archiving messages for long term and using messaging systems securely, i.e., so that they are encrypted end-to-end. If an end user encrypts a messages end-to-end, the archiving system fails to store it in clear text and make it possible for the end user to search the archive effectively. The MAS with encryption is capable of doing so since the private and public key are available to the designated mail server thus an encrypted message can be decrypted before it stored in the archive.

1. A method for processing and transforming electronic messages comprising the steps of:
(a) providing a message authentication server for receiving and responding to message verification requests;
(b) associating the message authentication server with a sender of electronic messages;
(c) storing at the message authentication server an identifying key of the sender of electronic messages;
(d) storing at the message authentication server information about a message sent by the sender of electronic messages;
(e) transforming the message with message verification information;
(f) transmitting the transformed message to a message recipient;
(g) receiving at the message authentication server a verification request from the message recipient;
(h) in response to the verification request, determining message verification information for the message; and
(i) upon determining message verification information for the message, sending a verification response to the message recipient based on at least some of the message verification information.

2. The method of claim 1, wherein step (e) comprises the step of encrypting the message.

3. The method of claim 1, wherein step (e) comprises the step of adding to the message a sender authorization key.

4. The method of claim 3 wherein the sender authorization key is an X-AUTH-KEY.

5. The method of claim 3, wherein step (g) comprises the step of receiving with the verification request a sender authorization key of the message.

6. The method of claim 1 wherein step (b) comprises the step of providing a message authentication directory.

7. The method of claim 6 where in step of providing a message authentication directory comprises the step of providing a listing of message authentication servers wherein the listing includes associations between senders of messages and message authentication servers for the senders.

8. The method of claim 7 wherein step (e) comprises the step of adding to the message a sender authorization key.

9. The method of claim 8, wherein step (g) comprises the step of receiving with the verification request a sender authorization key of the message.

10. The method of claim 9 wherein:
step (h) comprises the step of determining whether the verification request includes a valid sender authorization key; and
step (i) comprises the step of incrementing a counter for the message only if the verification request includes a valid sender authorization key.

11. The method of claim 10 wherein the counter is a X-AUTH-COUNTER counter.

12. The method of claim 10 wherein the sender authorization key is an X-AUTH-KEY.

13. The method of claim 1 wherein step (g) comprises the steps of:
(i) generating at the message recipient the verification request; and
(ii) transmitting the verification request from the recipient to the message authentication server.

14. The method of claim 1 where in step (g) comprises the steps of:
(i) determining at the message recipient whether the message has a authorization key;
(ii) locating information for the sender stored in a network of addresses database maintained by the recipient; and
(iii) transmitting the verification request from the recipient to the message authentication server.

15. An electronic message processing and transformation system comprising:
(a) a message authentication server for receiving and responding to message verification requests;
(b) a message associator for associating the message authentication server with a sender of electronic messages;
(c) key storage for storing at the message authentication server an identifying key of the sender of electronic messages;
(d) message information storage for storing at the message authentication server information about a message sent by the sender of electronic messages;
(e) a message transformer for transforming the message with message verification information;
(f) a message transmitter for transmitting the transformed message to a message recipient; and
(g) a verification processor for receiving and processing a verification request from the message recipient.

16. The electronic message processing and transformation system of claim 15, wherein the verification processor comprises:
(a) a request receiver for receiving at the message authentication server a verification request from the message recipient;
(b) a message verification information processor for determining message verification information for the message in response to the verification request; and
(c) a verification information transmitter for sending, upon determining message verification information for the message, a verification response to the message recipient based on at least some of the message verification information.

17. The electronic message processing and transformation system of claim 16, wherein the message transformer comprises a sender authorization key generator.

18. The electronic message processing and transformation system of claim 16, wherein the message recipient comprises a verification request generator.

19. The electronic message processing and transformation system of claim 18, wherein the message recipient comprises a verification request transmitter.

20. The electronic message processing and transformation system of claim 19, wherein the message transformer comprises a sender authorization key generator.
